(19) United States
(12) Patent Application Publication
(10) Pub. No.: US 2016/0088033 A1
(43) Pub. Date: Mar. 24, 2016

(54) ELECTRONIC DEVICE AND METHOD FOR ESTABLISHING CONFERENCE CALL

(71) Applicant: CHIUN MAI COMMUNICATION SYSTEMS, INC., New Taipei (TW)

(72) Inventor: SHENG-HSIEN CHEN, New Taipei (TW)

(21) Appl. No.: 14/686,305

(22) Filed: Apr. 14, 2015

(30) Foreign Application Priority Data
Sep. 18, 2014 (CN) 201410478648.X

(51) Int. Cl. H04L 29/06; H04L 12/18; H04M 3/56

(52) U.S. Cl. CPC H04L 65/403; H04M 3/56; H04L 12/1822; H04M 2203/5063

(57) ABSTRACT

A method for establishing a conference call between an electronic device and client devices includes establishing the conference call between the electronic device and a first client device after receiving a first request from the first client device, and allowing a second client device to participate in the conference call after receiving a second request from the second client device. In response to receiving a first data package from the first client device, the electronic device converts a data format of the first data package to a first predetermined data format and sends the converted first data package to the second client device. In response to receiving a second data package from the second client device, the electronic device converts a data format of the second data package to a second predetermined data format and sends the converted second data package to the first client device.

### CROSS-REFERENCE TO RELATED APPLICATIONS

This application claims priority to Chinese Patent Application No. 201410478648.X filed on Sep. 18, 2014, the contents of which are incorporated by reference herein.

### FIELD

The subject matter herein generally relates to the field of communication technology, and particularly to establish a conference call.

### BACKGROUND

When a user is required to establish a conference call with other people, the user needs to dial a specified service number supplied by a telecom company (e.g., China mobile or China Unicom). According to the specified service number, the telecom company may establish the conference call by calling other persons to participate in the conference call. However, the cost to make this call using the specified service number is pretty high.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device including a conference call establishing system.

FIG. 2 is a block diagram of an example embodiment of function modules of the conference call establishing system in the electronic device of FIG. 1.

FIG. 3 is a flowchart of an example embodiment of a conference call establishing method using the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives.

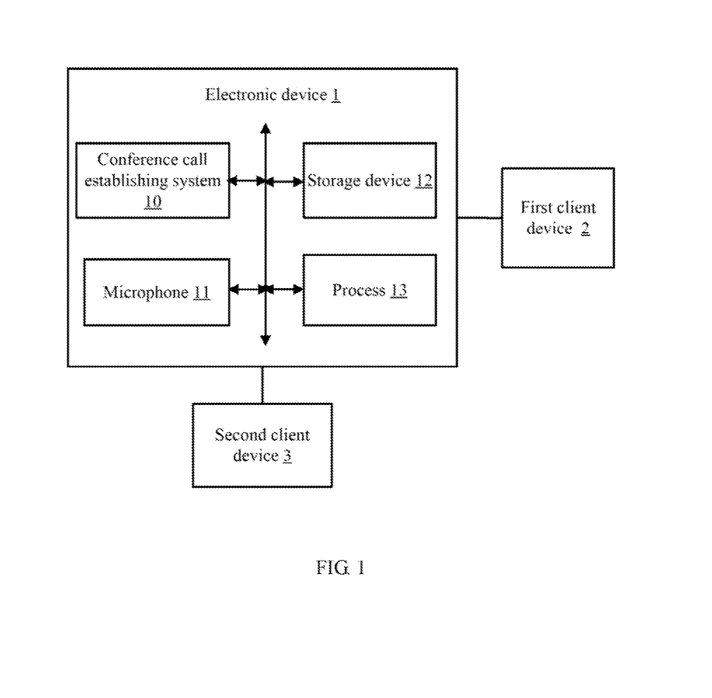

FIG. 1 is a block diagram of an example embodiment of an electronic device including a conference call establishing system. In at least one embodiment, an electronic device 1 includes a conference call establishing system 10. The electronic device 1 can be a smart phone, a personal digital assistant (PDA), a tablet computer, or other electronic device. The electronic device 1 further includes, but is not limited to, a microphone 11, a storage device 12, and at least one processor 13. FIG. 1 illustrates only one example of the electronic device, other examples can include more or fewer components than illustrated, or have a different configuration of the various components in other embodiments.

In at least one embodiment, the electronic device 1 is connected to a number of client devices. In at least one embodiment, for simplification, a first client device 2, and a second client device 3 are shown as example client devices in FIG. 1. The first client device 2 is connected to the electronic device 1 through a first predetermined network, for example, a communication network. The second client device 3 is connected to the electronic device 1 through a second predetermined network, for example, a local wireless network (LWN).

In at least one embodiment, the storage device 12 can include various types of non-transitory computer-readable storage mediums. For example, the storage device 12 can be an internal storage system, such as a flash memory, a random access memory (RAM) for temporary storage of information, and/or a read-only memory (ROM) for permanent storage of information. The storage device 12 can also be an external storage system, such as a hard disk, a storage card, or a data storage medium. The at least one processor 13 can be a central processing unit (CPU), a microprocessor, or other data processor chip that performs functions of the electronic device 1.

The conference call establishing system 10 can establish a conference call between the electronic device 1 and one or more client devices, such as the first client device 2 and the second client device 3, for example. Users of the electronic device 1, the first client device 2, and the second client device 3 can speak to each other via the conference call established by the conference call establishing system 10.

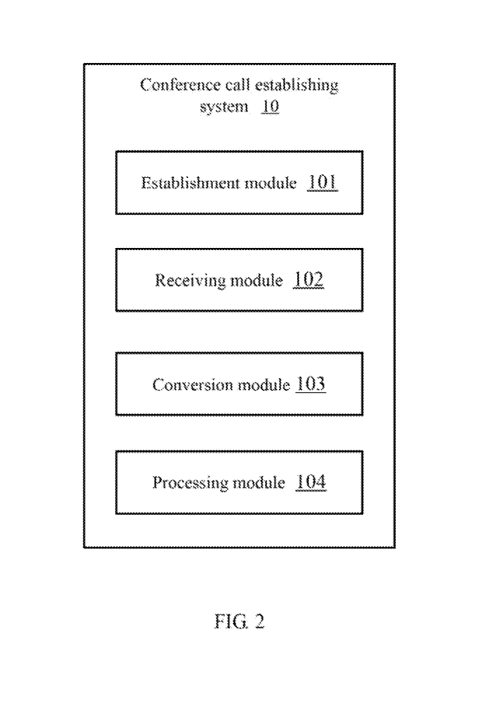

FIG. 2 is a block diagram of one embodiment of function modules of the conference call establishing system. In at least one embodiment, the conference call establishing system 10 can include an establishment module 101, a receiving module 102, a conversion module 103, and a processing module 104. The function modules 101, 102, 103, and 104 can include computerized codes in the form of one or more programs which are stored in the storage device 12. The at least one processor 13 executes the computerized codes to provide functions of the function modules 101-104.

The establishment module 101 establishes a conference call using the electronic device 1 after a first request to establish the conference call is received from a first client device 2. In at least one embodiment, the electronic device 1 is connected to the first client device 2 through the first predetermined network. When the first client device 2 transmits the first request to the electronic device 1 to establish the conference call, the establishment module 101 receives the first request and establishes the conference call.

The establishment module 101 allows a second client device 3 to participate in the conference call after a second request to participate in the conference call is received from the second client device 3. In at least one embodiment, the electronic device 1 is connected to the second client device 3 through the second predetermined network. The establishment module 101 provides an operation interface for a user to control one or more operations of the electronic device 1, such as receiving the first request and the second request. In some embodiments, the second request includes a telephone number and/or a name of a second user of the second client device 3.

The receiving module 102 receives a first data package from the first client device 2. In some embodiments, the first client device 2 acquires first voice information from a first user of the first client device 2, the first client device 2 packages the first voice information into the first data package. The receiving module 102 receives the first data package through the first predetermined network from the first client device 2. As mentioned above, the first data package includes the first voice information of the first user of the first client device 2.

The conversion module 103 converts a data format of the first data package to a first predetermined data format, and sends the converted first data package to the second client device 3. In some embodiments, the first predetermined data format is supported by the first predetermined network, thus, the first data package can be transmitted through the first predetermined network. The second client device 3 outputs the first voice information of the converted first data package to a second user after receiving the converted first data package from the electronic device 1, using a speaker of the second client device 3.

The receiving module 102 further receives a second data package from the second client device 3. In some embodiments, the second client device 3 acquires second voice information from a second user of the second client device 3, the second client device 3 packages the second voice information into the second data package.

The receiving module 102 receives the second data package through the second predetermined network from the second client device 3. As mentioned above, the second data package includes the second voice information from the second user of the second client device 3.

The conversion module 103 further converts a data format of the second data package to a second predetermined data format, and sends the converted second data package to the first client device 2. In some embodiments, the second predetermined data format is supported by the second predetermined network, thus, the second data package can be transmitted through the second predetermined network. The first client device 2 outputs the second voice information of the converted second data package to the first user after receiving the converted second data package from the electronic device 1, using a speaker of the first client device 2.

The processing module 104 acquires third voice information from a user of the electronic device 1. In at least one embodiment, when the user of the electronic device 1 speaks at the conference call, the microphone 11 of the electronic device 1 acquires third voice information of the user.

The processing module 104 sends the third voice information to the first client device 2 and the second client device 3. In some embodiments, the processing module 104 converts the third voice information into the first predetermined data format, and sends the converted third voice information to the first client device 2 through the first predetermined network. The processing module 104 also converts the third voice information into the second predetermined data format, and sends the converted third voice information to the second client device 2 through the second predetermined network. In some embodiments, the first predetermined data format can be the same as the second predetermined data format, or can be different from the second predetermined data format.

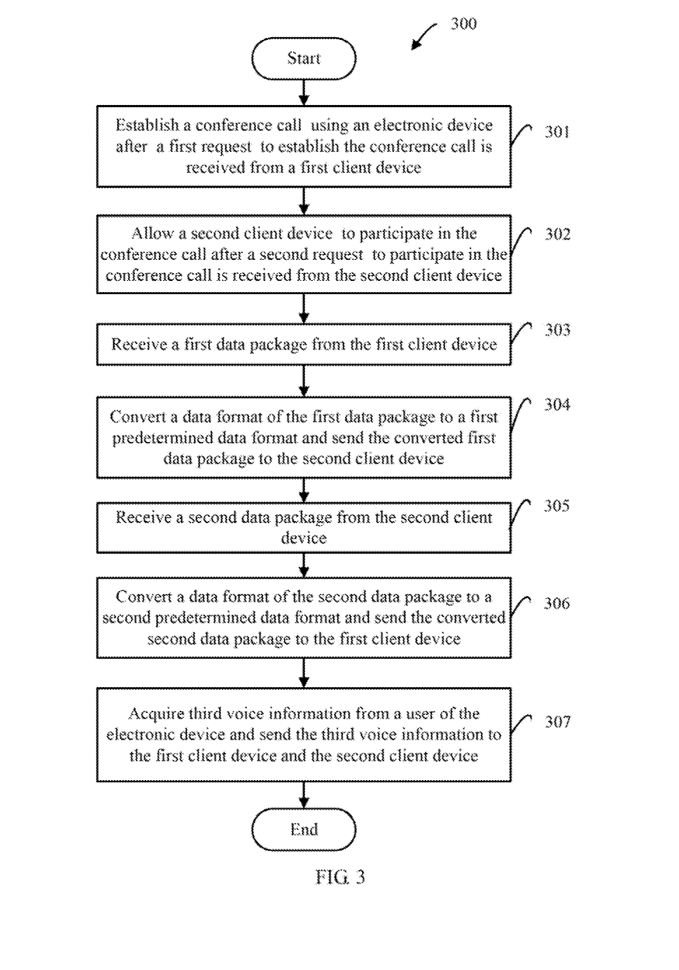

FIG. 3 illustrates a flowchart is presented in accordance with an example embodiment. An example method 300 is provided by way of example, as there are a variety of ways to carry out the method. The example method 300 described below can be carried out using the configurations illustrated in FIG. 1 and FIG. 2, and various elements of these figures are referenced in explaining the example method. Each block shown in FIG. 3 represents one or more processes, methods, or subroutines, carried out in the example method 300. Furthermore, the illustrated order of blocks is illustrative only and the order of the blocks can be changed according to the present disclosure. The example method 300 can begin at block 301. Depending on the embodiment, additional blocks can be utilized and the ordering of the blocks can be changed.

At block 301, an establishment module establishes a conference call using the electronic device 1 after a first request to establish the conference call is received from a first client device 2. In at least one embodiment, the electronic device 1 is connected to the first client device 2 through the first predetermined network. When the first client device 2 transmits the first request to the electronic device 1 to establish the conference call, the establishment module receives the first request and establishes the conference call according to the first request.

At block 302, the establishment module allows a second client device 3 to participate in the conference call after a second request to participate in the conference call is received from the second client device 3.

At block 303, a receiving module receives a first data package from the first client device 2. In some embodiments, the first client device 2 acquires first voice information from a first user of the first client device 2, the first client device 2 packages the first voice information into the first data package. The receiving module receives the first data package through the first predetermined network from the first client device 2. As mentioned above, the first data package includes the first voice information of the first user of the first client device 2.

At block 304, a conversion module converts a data format of the first data package to a first predetermined data format, and sends the converted first data package to the second client device 3. In some embodiments, the first predetermined data format is supported by the first predetermined network, thus, the first data package can be transmitted through the first predetermined network.

At block 305, the receiving module receives a second data package from the second client device 3. In some embodiments, the second client device 3 acquires second voice information from a second user of the second client device 3, the second client device 3 packages the second voice information into the second data package. The receiving module receives the second data package through the second predetermined network from the second client device 3.

At block 306, the conversion module converts a data format of the second data package to a second predetermined data format, and sends the converted second data package to the first client device 2. In some embodiments, the second predetermined data format is supported by the second predetermined network, thus, the second data package can be transmitted through the second predetermined network.

At block 307, a processing module acquires third voice information from a user of the electronic device 1, and sends the third voice information to the first client device 2 and the second client device 3. In at least one embodiment, when the user of the electronic device 1 speaks at the conference call, the microphone 11 of the electronic device 1 acquires third voice information of the user. In some embodiments, the processing module converts the third voice information into the first predetermined data format, and sends the converted third voice information to the first client device 2 through the first predetermined network. The processing module also converts the third voice information into the second predetermined data format, and sends the converted third voice information to the second client device 2 through the second predetermined network. In some embodiments, the first predetermined data format can be the same as the second predetermined data format, or can be different from the second predetermined data format.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device, the electronic device being connected to client devices, the electronic device comprising:
at least one processor; and
a storage device configured to store one or more programs which, when executed by the at least one processor, cause the at least one processor to:
establish a conference call using the electronic device after a first request to establish the conference call is received from a first client device;
allow a second client device to participate in the conference call after a second request to participate in the conference call is received from the second client device;
receive a first data package from the first client device;
convert a data format of the first data package to a first predetermined data format, and send the converted first data package to the second client device;
receive a second data package from the second client device; and
convert a data format of the second data package to a second predetermined data format, and send the converted second data package to the first client device.

2. The electronic device according to claim 1, wherein the first data package comprises first voice information from a first user of the first client device, and the second data package comprises second voice information from a second user of the second client device.

3. The electronic device according to claim 2, wherein the first client device outputs the second voice information of the converted second data package after receiving the converted second data package.

4. The electronic device according to claim 2, wherein the second client device outputs the first voice information of the converted first data package after receiving the converted first data package.

5. The electronic device according to claim 1, wherein the at least one processor further:
acquires third voice information from a user of the electronic device; and
sends the third voice information to the first client device and the second client device.

6. A computer-implemented method for establishing a conference call using an electronic device being executed by at least one processor of the electronic device, the electronic device being connected to client devices, the method comprising:
establishing a conference call using the electronic device after a first request to establish the conference call is received from a first client device;
allowing a second client device to participate in the conference call after a second request to participate in the conference call is received from the second client device;
receiving a first data package from the first client device;
converting a data format of the first data package to a first predetermined data format, and sending the converted first data package to the second client device;
receiving a second data package from the second client device; and
converting a data format of the second data package to a second predetermined data format, and sending the converted second data package to the first client device.

7. The method according to claim 6, wherein the first data package comprises first voice information from a first user of the first client device, and the second data package comprises second voice information from a second user of the second client device.

8. The method according to claim 7, wherein the first client device outputs the second voice information of the converted second data package after receiving the converted second data package.

9. The method according to claim 8, wherein the second client device outputs the first voice information of the converted first data package after receiving the converted first data package.

10. The method according to claim 6, further comprising:
acquiring third voice information from a user of the electronic device; and
sending the third voice information to the first client device and the second client device.

11. A non-transitory storage medium having stored thereon instructions that, when executed by a processor of an electronic device, causes the processor to perform a method for establishing a conference call, the electronic device being connected to client devices, the method comprising:
establishing a conference call using the electronic device after a first request to establish the conference call is received from a first client device;
allowing a second client device to participate in the conference call after a second request to participate in the conference call is received from the second client device;
receiving a first data package from the first client device;
converting a data format of the first data package to a first predetermined data format, and sending the converted first data package to the second client device;
receiving a second data package from the second client device; and
converting a data format of the second data package to a second predetermined data format, and sending the converted second data package to the first client device.

12. The non-transitory storage medium according to claim 11, wherein the first data package comprises first voice information from a first user of the first client device, and the second data package comprises second voice information from a second user of the second client device.

13. The non-transitory storage medium according to claim 12, wherein the first client device outputs the second voice information of the converted second data package after receiving the converted second data package.

14. The non-transitory storage medium according to claim 13, wherein the second client device outputs the first voice information of the converted first data package after receiving the converted first data package.

15. The non-transitory storage medium according to claim 11, wherein the method further comprises:
acquiring third voice information from a user of the electronic device; and
sending the third voice information to the first client device and the second client device.
